(19) United States
(12) Patent Application Publication
(10) Pub. No.: US 2025/0141009 A1
(43) Pub. Date: May 1, 2025

(54) BATTERY SYSTEM FOR SUPPLYING POWER TO A DRIVE UNIT OF A BICYCLE, BICYCLE, AND METHOD FOR ASSEMBLY OF A BATTERY SYSTEM

(71) Applicant: PORSCHE EBIKE PERFORMANCE GMBH, Ottobrunn (DE)

(72) Inventor: Oskar KAUFMANN, München (DE)

(21) Appl. No.: 18/835,614

(22) PCT Filed: Feb. 2, 2023
(86) PCT No.: PCT/EP2023/052587

§ 371 Date: Aug. 2, 2024

(30) Foreign Application Priority Data
Feb. 3, 2022 (DE) 10 2022 102 603.5

(51) Int. Cl. H01M 50/242; B62J 43/13; B62J 43/28; H01M 50/213; H01M 50/249; H01M 50/264; H01M 50/271

(52) U.S. Cl. CPC H01M 50/242; B62J 43/13; B62J 43/28; H01M 50/213; H01M 50/249; H01M 50/264; H01M 50/271; H01M 2220/20

(57) ABSTRACT

A battery system for supplying power to a drive unit of a bicycle, includes a housing, wherein a battery module with at least one battery cell is arranged in the housing. The housing is a pot-like housing part, the pot-like housing part has a peripheral housing wall and a bottom formed in one piece therewith, the housing has a closure element, and the battery module is fixedly connected to the bottom. A bicycle having a battery system and a method for assembly of a battery system are also related.

### CROSS-REFERENCE TO RELATED APPLICATIONS

This application is a 35 U.S.C. § 371 National Stage patent application of PCT/EP2023/052587 filed 2 Feb. 2023, which claims the benefit of German patent application 10 2022 102 603.5 filed 3 Feb. 2022, the disclosures of which are incorporated herein by reference in their entirety.

### TECHNICAL FIELD

The disclosure relates to a battery system for the power supply of a drive unit of a bicycle, comprising a housing and a battery module arranged therein according to Claim 1. The disclosure further relates to a bicycle having such a battery module according to Claim 9 and a method for assembling a battery system according to Claim 10.

### BACKGROUND

Battery systems for the power supply of a drive unit of a bicycle are well known. Such bicycles with battery system are also referred to as e-bikes or pedelecs. The battery systems usually comprise a housing in which one or a plurality of battery cells are arranged and protected against external influences. A plurality of battery cells are usually combined in a battery module and interconnected within the battery module.

The battery systems are exposed to vibrations while driving or even during transport. As part of the approval procedure for a battery system, the so-called UN transport test (UN 38.3) is used to check how stable the battery system is against accelerations and vibrations in order to ensure the safest possible operation of a battery system.

### SUMMARY

Against this background, the disclosure provides a battery system, a bicycle with such a battery system and a method for assembling a battery system, wherein the battery system is particularly stable against accelerations and vibrations.

The solution is carried out according to the disclosure with the features of the independent claims. Further embodiments and advantages are described in connection with the dependent claims.

The battery system according to the disclosure is used to power a drive unit of a bicycle. The battery system comprises a housing, wherein a battery module with at least one battery cell is arranged in the housing.

The housing surrounds the battery module, in particular, from all sides and serves to protect the battery module with the at least one battery cell. In particular, the battery module has a plurality of battery cells and preferably 24 battery cells each having a capacity of 3.6 V. In particular, the battery cells are connected in such a way that 12 battery cells are arranged serially in two parallel strings (12s2p). The arrangement of the battery cells is carried out, in particular, in two layers with two rows of battery cells with 4 batteries each. The battery cells are cylindrical in particular. The battery module is, in particular, a battery module with a supply voltage in the range of low voltage. The nominal voltage of the battery module is, in particular, below 60 V and is preferably 43 V.

The housing comprises a pot-like housing part, wherein the pot-like housing part comprises a circumferential housing wall and a base formed as a single piece with it. The pot-like housing part has an insertion opening. The housing also has a closure element, which serves to close the insertion opening. The housing part can also be referred to as a chalice, wherein the housing part is formed as a single piece and has only one insertion opening. The insertion opening is used to insert the battery module into the housing.

The battery module is particularly oblong and comprises a plurality of oblong, successively arranged battery cells. The battery cells are cylindrical in particular. The housing is accordingly also oblong. The base of the housing part and the closure element form the short sides of the housing in particular. In particular, the pot-like housing part is produced by means of an extrusion process. The housing is made of aluminium in particular.

According to the disclosure, the battery module is firmly connected to the base. Here, “firmly connected” means that the battery module and the base are connected to each other in a form- and/or force-fit manner. The battery module is stored and connected via the base of the housing part and, in particular, exclusively via the base. The connection between battery module and base is, in particular, detachable to enable removal of the battery module, e.g., for repair purposes.

A connection of the battery module to the base, which in turn is connected as a single piece to the further housing part, has the advantage that forces during the journey and/or the transport of the battery system, which act in the direction of the base (axial forces), can be absorbed particularly well. By connecting the battery module to the base connected to the circumferential housing wall, it can be safely avoided that the battery module falls out, e.g. in a UN transport test mentioned above. This ensures that the battery module is stored safely and as free of backlash as possible within the housing and does not move within the housing. Too much room for manoeuvre can lead to damage to the battery module and housing.

Due to the omission of the seal on the base, because of the single-piece formation of the pot-like housing part, the housing can be significantly shorter compared to known housings with detachable base and closure element. Lengths of 366 mm could be achieved here. In addition, only one sealing surface is provided in the area of the closure element and thus the potential entry point for moisture and contamination is significantly reduced.

In particular, the battery module is firmly connected exclusively to the base of the housing. In particular, the battery module is connected exclusively to the base of the housing in the axial direction of the housing (wherein the axial direction extends from the base to the closure element). Any lateral support of the battery module without a positive- and/or non-positive-locking connection to a housing wall should not be considered as firmly connected here. If, in particular, only the base serves to attach the battery module in the housing and no connection of the battery module to the closure element takes place, no forces act on the connected closure element—only being detachably connected to the housing part. The closure element then serves exclusively to seal the housing.

As mentioned above, the battery module is attached to the base, in particular, by means of at least one fastening means. The fastening means extends, in particular, from the outer side of the base through the base to the interior of the housing to the battery module. Preferably, it is a fastening means which allows a detachable attachment of the battery module to the base. In particular, it is in the at least one fastening means to a screw.

In a practical embodiment of the battery system according to the disclosure, the battery module comprises a clamping system, wherein the clamping system comprises a base plate which is arranged on one base side of the battery module and wherein the clamping system comprises a cover plate arranged on one cover of the battery module opposite the base side. The base plate and the cover plate are, in particular, each flat, plate-like elements. The base plate and the cover plate limit the battery module, particularly in the axial direction. The base plate and the cover plate are arranged, in particular, on a first front side and a second front side of the battery module. The cover plate and the base plate are connected by at least one connecting element. Through the cover plate, the base plate and the connecting element, the battery module can be clamped and compressed.

The clamping system serves, in particular, as a point of attack for a fastening of the battery module described above with the base of the pot-like housing part. In particular, the fastening means for connecting the battery module to the base is directly or indirectly connected to the connecting element. This avoids damage to the battery cells and the clamping system also provides a good way to fix the entire battery module by means of connecting elements arranged only on one side (only on the base).

The base plate and/or the cover plate may be made of glass fibre reinforced plastic. It is also conceivable to form the base plate and/or the cover plate made of plastic, metal or carbon. The base plate and/or cover plate have, in particular, a circumferential chamfer.

In a further practical embodiment, the at least one connecting element extends laterally of the at least one battery cell. In the case of a plurality of rows of battery cells, in particular, a plurality of connecting elements are arranged between individual rows of battery cells. As described in more detail below, the connection of the battery module to the base can be made, in particular, directly or indirectly via the connecting element.

Due to the lateral arrangement of the at least one connecting element, the risk of damage to the battery cells is minimized. If the battery module has a plurality of rows of battery cells and a plurality of connecting elements, the battery module is connected to the base, in particular, with a plurality of fastening means.

The at least one connecting element for connecting the base plate and the cover plate is, in particular, a threaded rod. It is also conceivable to use a simple rod, rope or spokes or to connect the cover plate and the base plate by plastic injection moulding.

In a practical embodiment of the battery system according to the disclosure, the connecting element is connected to a clamping element. A clamping element is, in particular, a clamping nut. Specifically, a clamping nut can be connected to a threaded rod as a connecting element. By tightening the clamping nut, the cover plate and the base plate can be moved towards each other and thus the battery module can be clamped with the battery cells. The at least one connecting element is connected to the cover plate in particular. It may also be two connecting elements indirectly connected to the cover plate by connecting two connecting elements to a plate or, respectively, to a metal sheet (e.g. by welding, screwing or riveting), wherein the plate or the metal sheet presses against the cover plate in the clamped state.

In particular, the fastening means is connected to the clamping element and thus indirectly to the connecting element. The clamping nut therefore also serves as a way to connect the battery module to the base simultaneously.

The disclosure also relates to a bicycle having a battery system as described above. In particular, the bicycle is an electric bicycle. The battery system serves to power a drive unit, which offers additional support when pedalling.

Furthermore, the disclosure relates to a method for assembling a battery system as described above, wherein a pot-like housing part is first generated and a battery module with at least one battery cell is provided. The battery module is inserted into the pot-like housing part via an insertion opening and the battery module is connected to the base of the housing part. Subsequently, a closure element is placed on the housing part. Due to the single-piece formation of the pot-like housing part, among other things, advantages in terms of length and sealing of the housing result as described above. The method for assembling a battery system is not the assembly of a finished battery system, for example in an electric bicycle, but rather the assembly of the individual components of the battery system and thus the completion of the battery system itself. This battery system must then be integrated into an electric bicycle in later steps.

In particular, the battery module is connected exclusively to the base of the pot-like housing part. As a result, assembly is particularly fast and the bearing forces are only absorbed via the base connected to the housing wall as a single piece. This prevents the battery module from falling out while driving, transporting or carrying out a transport test.

For the single-piece formation of the pot-like housing part with circumferential housing wall and base, production by means of extrusion is particularly suitable.

In a further practical embodiment of the method according to the disclosure, the battery module is clamped in the axial direction by means of a clamping system before insertion into the housing. For this purpose, in particular, a base plate and a cover plate are each arranged on one base side or a cover side of the battery module and the base plate and the cover plate are connected to each other with at least one connecting element. This simplifies the handling of the battery cells.

In particular, the battery module is preloaded in that the base plate by means of a clamping element along the connecting element in the direction of the cover plate, wherein the cover plate serves as a counter bearing for battery cells arranged between the cover plate and the base plate. The connecting element is, in particular, a threaded rod and the clamping element is a clamping nut.

In particular, the connection of the battery module and the base of the housing part is made by connecting the base to the clamping system. To attach the battery module to the base, in particular, a screw is screwed into a clamping element, in particular, a clamping nut. The fastening means is then indirectly connected to the connecting element.

### BRIEF DESCRIPTION OF THE DRAWINGS

Further practical embodiments and advantages are described below in connection with the figures. The figures show:

FIG. 1 a battery system in a perspective view obliquely from above,

FIG. 2 a battery module in a perspective view diagonally from the front,

FIG. 3 the battery module from FIG. 3 in a perspective view diagonally from behind,

FIG. 4 the battery system from FIG. 1 in a sectional view in accordance with section line IV-IV,

FIG. 5 the area marked with V in FIG. 4 in an enlarged view,

FIG. 6 the battery system from FIG. 1 in a sectional view in accordance with section line VI-VI,

FIG. 7 the area marked with VII in FIG. 6 in an enlarged view,

FIG. 8 a clamping system in a perspective view obliquely from the front, and

FIG. 9 the clamping system from FIG. 8 in a perspective view diagonally from behind.

### DETAILED DESCRIPTION OF THE DRAWINGS

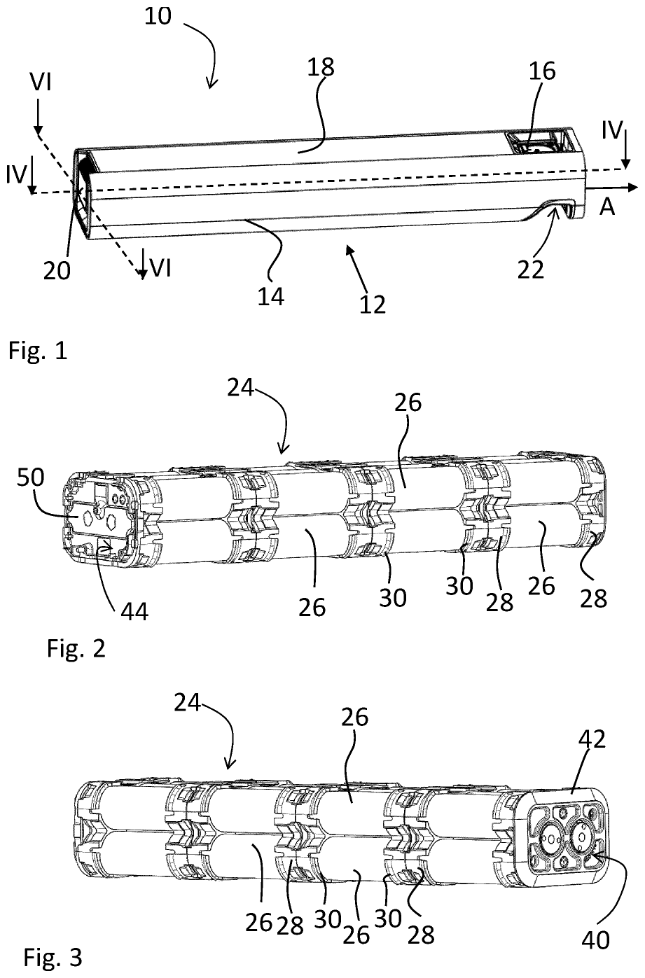

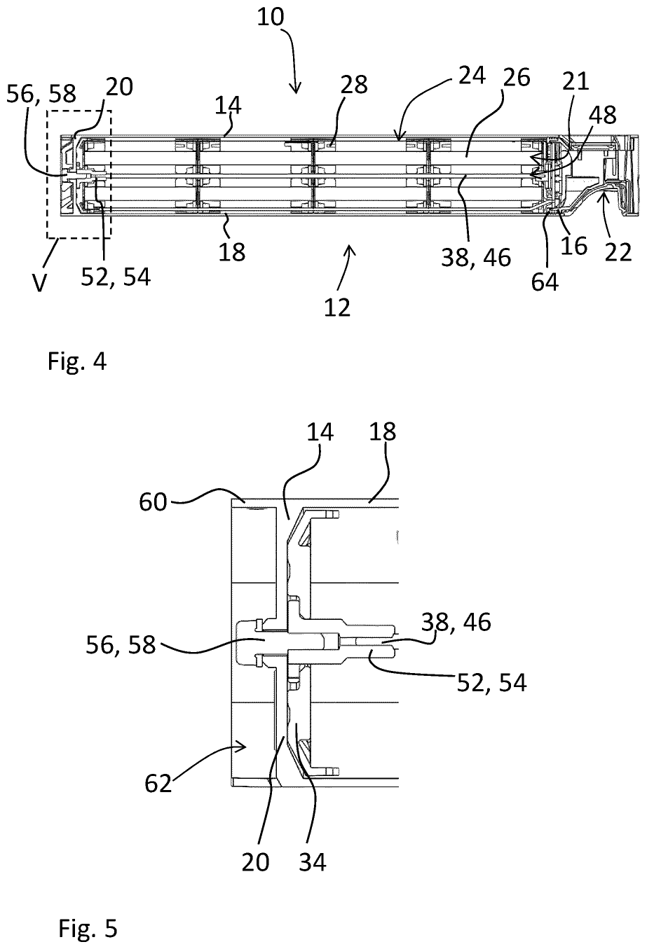

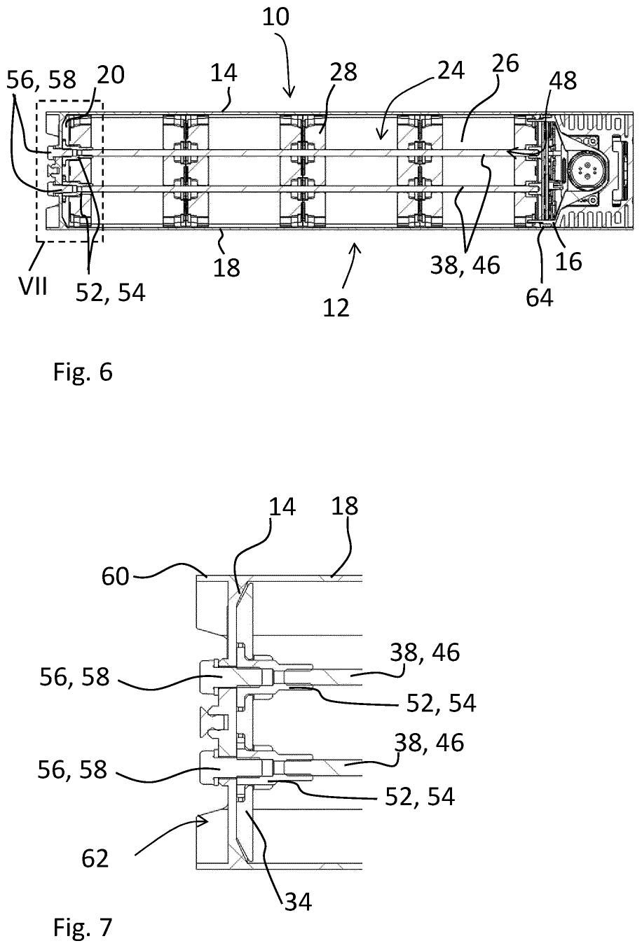

FIG. 1 shows a battery system 10. The battery system 10 comprises a housing 12 with a pot-like housing part 14 and a closure element 16. The housing 12 is made of aluminium and manufactured by means of extrusion. The housing part 14 is designed like a pot (see also FIG. 4 and FIG. 6) and comprises a circumferential housing wall 18 and a base 20 formed as a single piece therewith, as well as an insertion opening 21 (see FIG. 4). The housing 14 also comprises a recessed grip 22, which is formed here on the pot-like housing part 14.

The housing 12 is oblong here and has an axial direction A.

In the FIGS. 2 and 3, a battery module 24 is shown, which is arranged within the housing 12. The battery module 24 comprises here 16 cylindrical battery cells 26, which are arranged in two layers with two rows of four battery cells 26 each. At the ends of the battery cells 26, cell holders 28 are arranged. The cell holders 28 have spring-elastic lugs 30, which serve for radial support of the battery cells 26 in the housing 12.

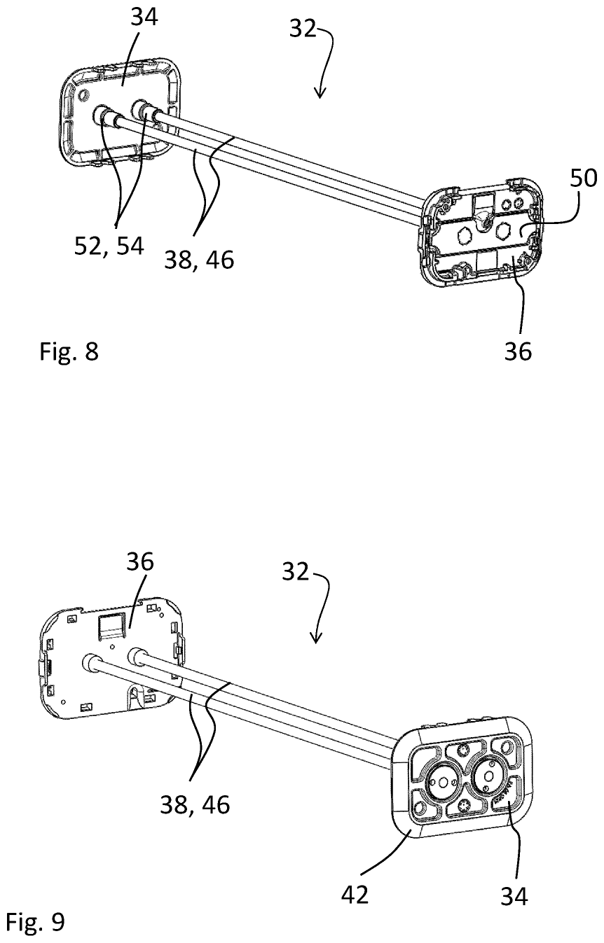

Furthermore, the battery module 24 comprises a clamping system 32, which comprises a base plate 34, a cover plate 36 and a plurality of connecting elements 38. The clamping system 32 is shown in FIGS. 8 and 9 separately, without battery cells 26 shown. The base plate 34 is arranged on one base side 40 of the battery module 24, wherein the base side 24 is facing the base 20 of the pot-like housing part 14 in an arrangement of the battery module 24 in the housing 12. The base plate 34 has a circumferential chamfer 42. The cover plate 36 is arranged on a cover side 44 of the battery module 24, wherein the cover side 44 is facing the closure element 16 in an arrangement of the battery module 24 in the housing 12.

The cover plate 36 and the base plate 34 are connected here by means of two connecting elements 38. As connecting elements 38 serve here threaded rods 46. From a combination of FIGS. 5 and 7, it can be seen that the connecting elements 38 each extend in axial direction in the intermediate spaces 48 at the joints of the four adjacent rows of battery cells 26.

The tensioning of the battery cells 24 by the clamping system 32 is carried out by the threaded rods 46 are connected (welded) to a metal sheet 50, which is attached to the cover plate 36. At the lower ends of the threaded rods 46, which protrude through the base plate 34, clamping elements 52, here arranged in the form of clamping nuts 54, by means of which the cover plate 36 is guided in the direction of the base plate 34. The battery cells 26 are thus clamped by the clamping system 32 in the axial direction.

The arrangement and, in particular, attachment of the battery module 24 in the housing 12 is described below in conjunction with the FIGS. 4 to 7. The battery module 24 is firmly connected in the embodiment shown only to the base 20. That is, the battery module 24 is connected here only to the base 20 in a positive- and a non-positive-locking manner. The attachment to the base 20 means that the force absorption when accelerating the battery module 24 in the axial direction A occurs only through the base 20.

The attachment of the battery module 24 to the base 20 is carried out via a screw 56 as fastening means 58. The screw 56 is screwed from the outer side of the housing part 14 through the base 20 and screwed to the clamping nut 54. In the present case, two screws 56 are provided, each of which engage in the clamping nuts 54 connected to the threaded rods 46. The screws 56 are then each arranged in an extension of the intermediate spaces 48 between adjacent rows of battery cells 26. The housing part 14 has a circumferential collar 60 at the base 20, which forms a recess 62, so that the screws 56 do not protrude from the outer edge of the housing part 14.

An attachment of the battery module 24 to the closure element 16 does not take place. Accordingly, the closure element 16 does not have to absorb any bearing forces. The closure element 16 comprises a circumferential seal 64 for sealing an insertion opening 21 of the housing part 14 (see FIG. 4 and FIG. 6).

1. A battery system for the power supply of a drive unit of a bicycle, with a housing, wherein, in the housing, a battery module with at least one battery cell is arranged, wherein the housing comprises a pot housing part, wherein the pot housing part comprises a circumferential housing wall and a base formed as a single piece therewith, wherein the housing comprises a closure element, and wherein the battery module is firmly connected to the base.

2. The battery system according to claim 1, wherein the battery module is attached to the base with at least one fastening means.

3. The battery system according to claim 1, wherein the battery module comprises a clamping system, wherein the clamping system comprises a base plate which is arranged on the base side of the battery module, and a cover plate, which is arranged on one cover side of the battery module opposite the base side, and at least one connecting element, which connects the cover plate and the base plate.

4. The battery system according to claim 1, wherein the connecting element extends laterally of the at least one battery cell.

5. The battery system according to claim 3, wherein the at least one connecting element for connecting the base plate and the cover plate is a threaded rod.

6. The battery system according to claim 3, wherein the clamping system further comprises a clamping element by which the battery module is clamped in the axial direction.

7. The battery system according to claim 3, wherein the fastening means for attaching the battery module is connected to an element of the clamping system.

8. The battery system according to claim 1, wherein the base of the housing has a recess on the outer side, in which the at least one fastening means is arranged.

9. A bicycle with a battery system according to claim 1.

10. A method for assembling a battery system according to claim 1, wherein a pot-housing part is produced, a battery module with at least one battery cell is provided, the battery module is inserted into the housing part and the battery module is connected to the base of the housing part, and a closure element is placed on the housing part.

11. The method according to claim 10, wherein the pot housing part is produced by extrusion.

12. The method according to claim 10, wherein the battery module is clamped before insertion into the housing part by a clamping system in the axial direction.

13. The method according to claim 12, wherein the battery module is preloaded in that a base plate is guided by a clamping element along a connecting element in the direction of a cover plate, wherein the cover plate serves as a counter bearing for battery cells arranged between the cover plate and the base plate.

14. The method according to claim 12, wherein the connection of the battery module and the base of the housing part is carried out by connecting the base to the clamping system.
